(19) United States
(12) Patent Application Publication
(10) Pub. No.: US 2026/0176535 A1
(43) Pub. Date: Jun. 25, 2026

(54) METHOD FOR CATALYST-ASSISTED MICROWAVE PYROLYSIS OF WASTE PLASTICS

(71) Applicants: MEI LIN Holdings Ltd., Kaohsiung City (TW); MEI LIN ENERGY TECHNOLOGY CO., Ltd., Kaohsiung City (TW)

(72) Inventors: Min-Hang Weng, Kaohsiung City (TW); Ru-Yuan Yang, Kaohsiung City (TW)

(73) Assignees: MEI LIN Holdings Ltd., Kaohsiung City (TW); MEI LIN ENERGY TECHNOLOGY CO., Ltd., Kaohsiung City (TW)

(21) Appl. No.: 19/199,304

(22) Filed: May 5, 2025

(30) Foreign Application Priority Data
Dec. 23, 2024 (TW) 113150431

(51) Int. Cl. C10B 57/06; C01B 32/05; C10B 19/00; C10B 53/07; H05B 6/80

(52) U.S. Cl. CPC C10B 57/06; C01B 32/05; C10B 19/00; C10B 53/07; H05B 6/80

(57) ABSTRACT

A method for catalyst-assisted microwave pyrolysis of waste plastics includes: crushing a piece of waste plastic into multiple plastic fragments; mixing the multiple plastic fragments uniformly with a catalyst substance and placing the mixed plastic fragments and catalyst substance into a microwave heating chamber; performing a microwave heating process to heat the multiple plastic fragments under an oxygen-free condition within the microwave heating chamber to form solid carbon materials and gaseous volatile substances; and transferring the solid carbon materials from the microwave heating chamber into a cooling container and directing the gaseous volatile substances from at least one gas outlet of the microwave heating chamber into a condensation pipeline to form a fuel oil in a collection container.

### CROSS-REFERENCE TO RELATED APPLICATION

This application claims priority to and the benefit of Taiwan Patent Application Ser. No. 113150431, filed on Dec. 23, 2024, the entirety of which is incorporated by reference herein.

### FIELD

The present disclosure relates to a method for treating waste plastics, and more particularly to a method for treating waste plastics with catalyst-assisted microwave pyrolysis.

### BACKGROUND

Plastics are petroleum-based products that do not naturally exist in the environment and therefore cannot decompose naturally to re-enter the ecological cycle. If the plastics are not properly treated, they will become the so-called “eternal waste.” Waste plastic containers come in various materials. To facilitate public recycling, the containers do not need to be sorted according to different materials. Instead, the containers are collected by recycling vendors, who then sort, compress, and package them before sending them to plastic regeneration plants for processing. The processing flow at plastic regeneration plants mainly includes crushing, washing, floating to remove impurities, and dehydrating to produce single-material plastic fragments. These fragments are then melted and extruded to produce various types of regenerated plastic materials. Among these materials, polyethylene terephthalate (PET) material can be directly sent to downstream regeneration plants or textile mills for the production of regenerated products through fiber extraction and weaving processes. Other materials such as polyethylene (PE), polypropylene (PP), polyvinyl chloride (PVC), and polystyrene (PS) must first be sent to pelletizing plants to be processed into secondary plastic raw materials. These regenerated materials can then be processed via injection molding or compression molding to form various plastic products.

However, currently, the value of physically regenerated plastic products is not high. Plastics are petrochemical products and can be further decomposed into their original material state through pyrolysis. Pyrolysis involves heating long-chain organic compounds in an anaerobic or oxygen-free environment to break their molecular bonds, ultimately decomposing them into smaller molecular byproducts (e.g., fuel oils) and water. Traditional pyrolysis recycling involves feeding waste plastics into oil conversion equipment, where they undergo processes like pyrolysis gasification, condensation, separation, and distillation to obtain plastic pyrolysis oil. If it is to be converted into liquid or gaseous fuel oils, additional distillation and condensation processes are required. The traditional pyrolysis recycling can handle waste plastics, used engine oil, and waste solvents without pretreatment and is easy to operate and can produce heavy oil fuel with a sulfur content of 1.0% to 1.3%, which can be refined into diesel and gasoline through fractionation. Additionally, the gas generated from the gasification of waste plastics, after desulfurization treatment, becomes medium-heating-value gas, which can be used as fuel for industrial processes or boilers. However, the pyrolysis temperature for waste plastics is very high, consuming significant energy, which has a certain impact on the recycling of waste plastics.

Microwave heating has three characteristics. 1. Instantaneity: high thermal efficiency and short heating time. 2. Selectivity: different materials have varying dielectric properties, resulting in significant differences in their heating characteristics within the microwave field. 3. Penetration: electromagnetic waves can penetrate the interior of a medium, so the microwaves has strong penetration capability. Many studies have shown that waste materials treated with microwave heating and pyrolysis can produce high-quality recycled materials, achieving the concept of a recycling economy for reuse. Compared to conventional heating technologies, microwave heating technology provides shorter heating times and does not involve direct contact with the heated material, improving the issues of high energy consumption and low efficiency of conventional heating technologies. Many studies have confirmed that adding catalysts to waste plastics can effectively reduce the temperature required for microwave pyrolysis and yield high-quality carbon materials and fuel oils. However, current catalyst-assisted microwave pyrolysis of waste plastics is still at the laboratory scale. The laboratory methods are often complex and unsuitable for industrial-scale microwave pyrolysis to recover high-quality carbon materials and fuel oils.

Accordingly, it is necessary to provide an industrial-scale, rapid, and environmentally friendly method for catalyst-assisted microwave pyrolysis of waste plastics.

### SUMMARY

In order to address the issues mentioned above, the primary objective of the present disclosure is to provide a method for catalyst-assisted microwave pyrolysis of waste plastics for the issues and shortcomings of the existing technology. The present method efficiently pyrolyzes waste plastics with microwaves at lower temperatures and normal pressure to recover high-value carbon materials and fuel oils. With the assistance of catalyst, the present method enables low-temperature pyrolysis of waste plastics under appropriate microwave power density and appropriate conditions to achieve higher recovery rates of high-value carbon materials, shorten reaction time, simplify the reaction process, conserve energy, and enable regeneration of high-quality fuel oil while meeting environmental protection requirements.

In order to achieve the objective of the present disclosure, the present disclosure provides a method for catalyst-assisted microwave pyrolysis of waste plastics including the steps:
Step (1): Crushing a piece of waste plastic into multiple plastic fragments having a length between 0.2 cm and 10 cm and a width between 0.2 cm and 10 cm;
Step (2): Mixing the multiple plastic fragments uniformly with a catalyst substance and placing the mixed plastic fragments and catalyst substance into a microwave heating chamber, the microwave heating chamber having at least one gas inlet and at least one gas outlet, and the at least one gas outlet being connected to an external extraction device via a pipeline;
Step (3): Performing a microwave heating process to heat the multiple plastic fragments under an oxygen-free condition within the microwave heating chamber to form solid carbon materials and gaseous volatile substances, wherein the oxygen-free condition is formed by introducing an inert gas into the microwave heating chamber via the at least one gas inlet, and the microwave heating process is performed at a temperature between 300° C. and 600° C. for 0.1 to 1 hour; and
Step (4): Transferring the solid carbon materials from the microwave heating chamber into a cooling container and directing the gaseous volatile substances from the at least one gas outlet of the microwave heating chamber into a condensation pipeline to form a fuel oil in a collection container.

According to one aspect of the present disclosure, the microwave heating chamber includes a ceramic container and an outer metal housing covering the ceramic container, the at least one gas inlet is located at a lower half of the ceramic container, and the at least one gas outlet is located at an upper half of the ceramic container.

According to one aspect of the present disclosure, in step (2), the catalyst substance is selected from a carbon-containing material, a metal particle, or a metal oxide powder.

According to one aspect of the present disclosure, in step (2), the catalyst substance is a carbon-containing material, and an amount of the catalyst substance mixed with the plastic fragments is between 1% and 20% by weight of the plastic fragments.

According to one aspect of the present disclosure, in step (2), the catalyst substance is a metal particle, and an amount of the catalyst substance mixed with the plastic fragments is between 0.5% and 5% by weight of the plastic fragments.

According to one aspect of the present disclosure, in step (2), the catalyst substance is a metal oxide powder, and an amount of the catalyst substance mixed with the plastic fragments is between 1% and 10% by weight of the plastic fragments.

According to one aspect of the present disclosure, in step (3), the microwave heating process provides a microwave power density that is between 0.1 kW/kg and 1 kW/kg, wherein kg is a unit of weight for the plastic fragments.

According to one aspect of the present disclosure, in step (3), the inert gas introduced in the microwave heating process is nitrogen with a flow rate ranging from 1 LPM/kg to 10 LPM/kg, wherein LPM is liters per minute (L/min), and kg is a unit of weight for the plastic fragments.

According to one aspect of the present disclosure, in step (3), the external extraction device extracts a gas generated by the plastic fragments out of the microwave heating chamber at a speed greater than or equal to a rate at which the gas is generated in the microwave heating process, so that the oxygen-free condition is maintained within the microwave heating chamber.

According to one aspect of the present disclosure, in step (4), the condensation pipeline is a pipeline with a reflux structure equipped with an insulation module.

The method for catalyst-assisted microwave pyrolysis of waste plastics according to the present disclosure provides the following effects:
1. A catalyst is added to the waste plastics to assist the waste plastics to be heated in microwave heating, which quickly heats the inside of the waste plastics, shortening the overall processing time, reducing the energy consumption of microwave power, and greatly saving energy.
2. Introducing an inert gas under a normal pressure and controlling a specific microwave power density and temperature can facilitate the degradation of organic materials in the waste plastics, thereby improving the recovery efficiency and effectiveness of carbon materials and fuel oils.
3. The regenerated fuel oil obtained from the microwave heating process can be reused to synthesize new plastic materials for various applications or directly used as fuel oil for vehicles, making the microwave heating process a green and environmentally friendly recycling method.

### BRIEF DESCRIPTION OF THE DRAWINGS

In order to make the above and other objectives, features, and advantages of the present disclosure more apparent and understandable, several preferred embodiments are described below in detail with reference to the accompanying drawings.

FIG. 1 shows a flowchart of a method for catalyst-assisted microwave pyrolysis of waste plastics according to the present disclosure.

### DETAILED DESCRIPTION

Although the present disclosure can be embodied in different forms, the drawings and the descriptions herein are the preferred embodiments of the present disclosure. Those skilled in the art will understand that the devices and methods specifically described herein and illustrated in the drawings are considered as examples of the present disclosure and are not limiting exemplary embodiments, and the scope of the present disclosure is defined solely by the claims. The features illustrated or described in connection with one exemplary embodiment can be combined with features of other embodiments. Such modifications and variations will fall within the scope of the present disclosure.

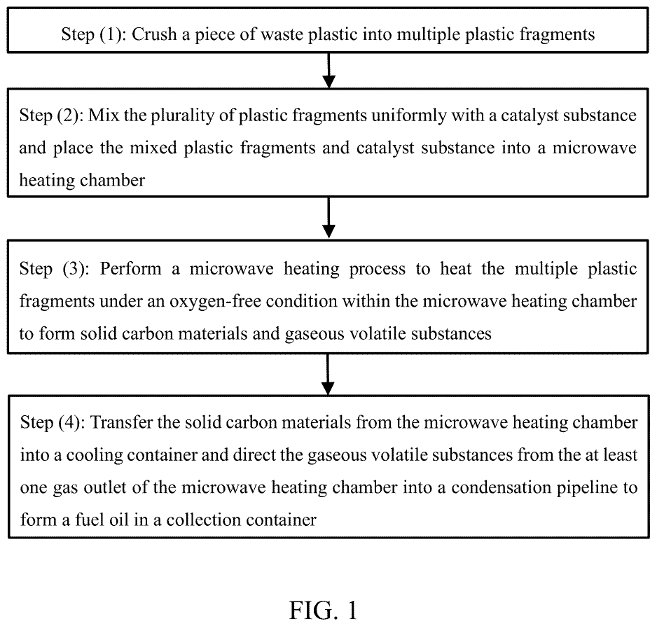

Pyrolysis is a thermochemical reaction process that decomposes organic materials into solid substances, condensed liquids, and combustible gases under high-temperature, oxygen-free, or oxygen-deficient conditions. In order to achieve the objective of the present disclosure, the present disclosure provides a method for catalyst-assisted microwave pyrolysis of waste plastics. FIG. 1 shows a flowchart of a method for catalyst-assisted microwave pyrolysis of waste plastics according to the present disclosure.

In order to achieve the objective of the present disclosure, the present disclosure provides a method for catalyst-assisted microwave pyrolysis of waste plastics including the steps:
Step (1): Crushing a piece of waste plastic into multiple plastic fragments having a length between 0.2 cm and 10 cm and a width between 0.2 cm and 10 cm. In the present embodiment, grinders, crushers, and shredders can be used to crush the piece of waste plastic into multiple plastic fragments.
Step (2): Mixing the multiple plastic fragments uniformly with a catalyst substance and placing the mixed plastic fragments and catalyst substance into a microwave heating chamber, the microwave heating chamber having at least one gas inlet and at least one gas outlet, and the at least one gas outlet being connected to an external extraction device via a pipeline. In the present embodiment, a mixing device, e.g., a mixer or a stirrer, can be used to mix the multiple plastic fragments uniformly with the catalyst substance, and a placing device, e.g., a conveyor belt, can be used to place the mixed plastic fragments and catalyst substance into the microwave heating chamber.
Step (3): Performing a microwave heating process to heat the multiple plastic fragments under an oxygen-free condition within the microwave heating chamber to form solid carbon materials and gaseous volatile substances, wherein the oxygen-free condition is formed by introducing an inert gas into the microwave heating chamber via the at least one gas inlet, and the microwave heating process is performed at a temperature between 300° C. and 600° C. for 0.1 to 1 hour. In the present embodiment, a microwave equipment with a microwave heating chamber can be used to perform the microwave heating process.
Step (4): Transferring the solid carbon materials from the microwave heating chamber into a cooling container and directing the gaseous volatile substances from the at least one gas outlet of the microwave heating chamber into a condensation pipeline to form a fuel oil in a collection container. In the present embodiment, a transferring device can be used to transfer the solid carbon materials from the microwave heating chamber into the cooling container, and a directing module, e.g., a directing pipeline, can be used to direct the gaseous volatile substances from the at least one gas outlet of the microwave heating chamber into the condensation pipeline.

The waste plastic includes materials, for example, polyethylene (PE), polypropylene (PP), polyvinyl chloride (PVC), polystyrene (PS), and polyethylene terephthalate (PET). In step (1), since the waste plastic is not a homogeneous substance, its different shapes and structures may affect heat transfer, which may further influence the effect of thermal pyrolysis. Therefore, a larger waste plastic can be crushed by mechanical processing. The plastic fragments have a length between 0.2 cm and 10 cm and a width between 0.2 cm to 10 cm. Preferably, the plastic fragments have a length between 0.2 cm and 1 cm and a width between 0.2 cm to 1 cm, which can increase the reaction rate.

In step (2), the microwave heating chamber includes a ceramic container and an outer metal housing covering the ceramic container. The at least one gas inlet is located at a lower half of the ceramic container, and the at least one gas outlet is located at an upper half of the ceramic container. With the at least one gas inlet arranged at the lower half of the ceramic container, airflow can be effectively provided to activate the entire microwave heating process. Multiple microwave power sources are disposed on the outer metal housing and configured to provide microwave power to the plastic fragments within the ceramic container of the microwave heating chamber. The required microwave power is determined based on the capacity of microwave heating chamber and the weight of the plastic fragments to be heated. The power of the microwave power sources is adjustable and provides appropriate power density based on the weight of the plastic fragments to be heated. Microwave is an electromagnetic wave that provides a microwave power at a frequency of either 915 MHz or 2450 MHz. The microwave heating process utilizes the principle of radiation, where microwaves enter the interior of the plastic fragments through the surfaces of the plastic fragments. The plastic fragments then absorbs the energy of the microwaves and converts it into heat, achieving the goal of heating and pyrolysis. The plastic fragments are placed into the microwave heating chamber from above and occupy about one-third to two-thirds of the space in the ceramic container of the microwave heating chamber.

In step (2), the catalyst substance is selected from a carbon-containing substance, a metal particle, a metal oxide powder, or a combination thereof. The catalyst substance can absorb microwave energy, and through uniformly mixing the catalyst substance with the plastic fragments, the plastic fragments can be heated evenly to accelerate the reaction rate. The carbon-containing substance can be selected from carbon black, graphite, activated carbon, carbon fiber, or a combination thereof. The metal particle can be selected from carbon iron, nickel-copper-zinc ferrite, nickel-zinc ferrite, manganese-zinc ferrite, a related metal substance, a nano-metal substance, or a combination thereof. The metal oxide powder can be selected from magnesium oxide, calcium oxide, strontium oxide, barium oxide, aluminum oxide, silicon oxide, iron oxide, zirconium oxide, vanadium oxide, titanium oxide, manganese oxide, cobalt oxide, nickel oxide, magnesium carbonate, calcium carbonate, strontium carbonate, barium carbonate, aluminum carbonate, or from other oxides or other oxycarbonate materials with high dielectric constants, or a combination thereof.

Preferably, in step (2), the catalyst substance is a carbon-containing material, and an amount of the catalyst substance mixed with the plastic fragments is between 1% and 20% by weight of the plastic fragments. Preferably, in step (2), the catalyst substance is a metal particle, and an amount of the catalyst substance mixed with the plastic fragments is between 0.5% and 5% by weight of the plastic fragments. Preferably, in step (2), the catalyst substance is a metal oxide powder, and an amount of the catalyst substance mixed with the plastic fragments is between 1% and 10% by weight of the plastic fragments. It should be noted that the catalyst substance can be added before, during, or after crushing the piece of waste plastic into multiple plastic fragments, as long as it is added before performing step (3).

In step (3), the microwave heating process provides a microwave power density that is between 0.1 kW/kg and 1 kW/kg, wherein kg is a unit of weight for the plastic fragments. In step (3), the inert gas introduced in the microwave heating process is nitrogen with a flow rate ranging from 1 LPM/kg to 10 LPM/kg, wherein LPM is liters per minute (L/min), and kg is a unit of weight for the plastic fragments. In step (3), the external extraction device extracts a gas generated by the plastic fragments out of the microwave heating chamber at a speed greater than or equal to a rate at which the gas is generated in the microwave heating process, so that the oxygen-free condition is maintained within the microwave heating chamber. The oxygen-free condition means that there is almost no oxygen present during the microwave heating process. By continuously introducing the inert gas, such as nitrogen or argon, the oxygen inside the microwave heating chamber is completely depleted, and no subsequent oxygen is replenished, achieving a limited air intake design. The flow rate for introducing the inert gas is proportional to a capacity of the microwave heating chamber.

In step (3), the microwave heating process is performed to heat the multiple plastic fragments to form solid carbon materials and gaseous volatile substances, and the microwave heating process is performed at a temperature between 300° C. and 600° C. for 0.1 to 1 hour. In order to increase the recycling rate of liquid fuel oil, in step (4), the solid carbon materials are transferred from the microwave heating chamber into a cooling container, and the gaseous volatile substances are directed from the at least one gas outlet of the microwave heating chamber into a condensation pipeline to form a fuel oil in a collection container. The condensation pipeline is a pipeline with a reflux structure equipped with an insulation module. The gaseous volatile substances are extracted from the microwave heating chamber by the external extraction device, and after a subsequent condensation process, the gaseous volatile substances are separated into liquid products, i.e., fuel oil, and gaseous products, i.e., syngas, which primarily include hydrogen, methane, and carbon monoxide. Both the liquid products and gaseous products can be used as energy fuels.

In step (4), the solid carbon materials are transferred from the microwave heating chamber to the cooling container for being cooled to a temperature below 200° C. and then outputted through a conveyor belt. After being cooled to a temperature below 200° C., the solid carbon materials can be discharged from the bottom of the microwave heating chamber without being oxidized or burned, and the cooling speed to room temperature can be accelerated.

Since the catalyst-assisted microwave heating process involves different catalysts, different amounts of catalyst to be added, different microwave power densities, different heating temperatures, different heating durations, different gases to be introduced, different flow rates of the introduced gas, and different control manners for gas extraction conditions, high-quality regenerated carbon materials and fuel oils can be effectively produced.

The method for catalyst-assisted microwave pyrolysis of waste plastics according to the present disclosure provides the following effects:
1. A catalyst is added to the waste plastics to assist the waste plastics to be heated in microwave heating, which quickly heats the inside of the waste plastics, shortening the overall processing time, reducing the energy consumption of microwave power, and greatly saving energy.
2. Introducing an inert gas under a normal pressure and controlling a specific microwave power density and temperature can facilitate the degradation of organic materials in the waste plastics, thereby improving the recovery efficiency and effectiveness of carbon materials and fuel oils.
3. The regenerated fuel oil obtained from the microwave heating process can be reused to synthesize new plastic materials for various applications or directly used as fuel oil for vehicles, making the microwave heating process a green and environmentally friendly recycling method.

Although the present disclosure has been disclosed in the preferred embodiments described above, these embodiments are not intended to limit the present disclosure. Any person skilled in the art can make various modifications and changes without departing from the spirit and scope of the present disclosure. As described above, various types of modifications and changes can be made without compromising the spirit of the present disclosure. Therefore, the scope of the present disclosure shall be defined by the appended claims.

What is claimed is:

1. A method for catalyst-assisted microwave pyrolysis of waste plastics, the method comprising:
step (1): crushing a piece of waste plastic into a plurality of plastic fragments having a length between 0.2 cm and 10 cm and a width between 0.2 cm and 10 cm;
step (2): mixing the plurality of plastic fragments uniformly with a catalyst substance and placing the mixed plastic fragments and catalyst substance into a microwave heating chamber, the microwave heating chamber having at least one gas inlet and at least one gas outlet, and the at least one gas outlet being connected to an external extraction device via a pipeline;
step (3): performing a microwave heating process to heat the plurality of plastic fragments under an oxygen-free condition within the microwave heating chamber to form solid carbon materials and gaseous volatile substances, wherein the oxygen-free condition is formed by introducing an inert gas into the microwave heating chamber via the at least one gas inlet, and the microwave heating process is performed at a temperature between 300° C. and 600° C. for 0.1 to 1 hour; and
step (4): transferring the solid carbon materials from the microwave heating chamber into a cooling container and directing the gaseous volatile substances from the at least one gas outlet of the microwave heating chamber into a condensation pipeline to form a fuel oil in a collection container.

2. The method of claim 1, wherein the microwave heating chamber includes a ceramic container and an outer metal housing covering the ceramic container, the at least one gas inlet is located at a lower half of the ceramic container, and the at least one gas outlet is located at an upper half of the ceramic container.

3. The method of claim 1, wherein in step (2), the catalyst substance is selected from a carbon-containing material, a metal particle, or a metal oxide powder.

4. The method of claim 3, wherein in step (2), the catalyst substance is the carbon-containing material, and an amount of the catalyst substance mixed with the plastic fragments is between 1% and 20% by weight of the plastic fragments.

5. The method of claim 3, wherein in step (2), the catalyst substance is the metal particle, and an amount of the catalyst substance mixed with the plastic fragments is between 0.5% and 5% by weight of the plastic fragments.

6. The method of claim 3, wherein in step (2), the catalyst substance is the metal oxide powder, and an amount of the catalyst substance mixed with the plastic fragments is between 1% and 10% by weight of the plastic fragments.

7. The method of claim 1, wherein in step (3), the microwave heating process provides a microwave power density that is between 0.1 kW/kg and 1 kW/kg, wherein kg is a unit of weight for the plastic fragments.

8. The method of claim 1, wherein in step (3), the inert gas introduced in the microwave heating process is nitrogen with a flow rate ranging from 1 LPM/kg to 10 LPM/kg, wherein LPM is liters per minute (L/min), and kg is a unit of weight for the plastic fragments.

9. The method of claim 1, wherein in step (3), the external extraction device extracts a gas generated by the plastic fragments out of the microwave heating chamber at a speed greater than or equal to a rate at which the gas is generated in the microwave heating process, so that the oxygen-free condition is maintained within the microwave heating chamber.

10. The method of claim 1, wherein in step (4), the condensation pipeline is a pipeline with a reflux structure equipped with an insulation module.
